(19) United States
(12) Patent Application Publication
(10) Pub. No.: US 2017/0021930 A1
(43) Pub. Date: Jan. 26, 2017

(54) CRADLE RECLINE MECHANISM FOR AIRCRAFT PASSENGER SEAT

(71) Applicant: B/E AEROSPACE, INC., Wellington, FL (US)

(72) Inventor: Robert J. HENSHAW, Newnan, GA (US)

(73) Assignee: B/E AEROSPACE, INC., Wellington, FL (US)

(21) Appl. No.: 15/289,150

(22) Filed: Oct. 8, 2016

Related U.S. Application Data
(63) Continuation-in-part of application No. 14/676,009, filed on Apr. 1, 2015.
(60) Provisional application No. 61/973,957, filed on Apr. 2, 2014.

(51) Int. Cl. B64D 11/06

(52) U.S. Cl. CPC B64D 11/064; B64D 11/0643

(57) ABSTRACT

In a preferred embodiment, a cradle recline mechanism for an aircraft passenger seat includes a guide mechanism for guiding a seat bottom of the aircraft passenger seat forward and lower as the seat bottom moves from an upright sitting position to a cradle recline sitting position, where a rear portion of the seat bottom is lowered more than a front portion of the seat bottom, causing the seat bottom to angle upwards from a bottom edge of the seat back. A seat back of the passenger seat may be pivotably connected to the seat bottom such that it is pulled forward and down with the movement of the seat bottom, with the recline angle determined by a rigid support mechanism disposed behind the seat back. Passenger weight may be counterbalanced using a moveable control mechanism such as a locking gas spring.

### CROSS REFERENCES TO RELATED APPLICATIONS

This application is a continuation-in-part of and claims priority from U.S. application Ser. No. 14/676,009, entitled “Cradle Recline Mechanism for Fixed-Shell Aircraft Seat” and filed Apr. 1, 2015, which claims priority from U.S. Provisional Application No. 61/973,957, filed Apr. 2, 2014, the contents of each which are incorporated by reference in their entirety.

### BACKGROUND

The present disclosure relates to a recline-capable fixed-shell aircraft seat, and more particularly, to a cradle recline mechanism for a fixed-shell aircraft seat in which the seat back reclines as the seat bottom translates forward and lower to the floor, providing greater comfort with less pitch thereby reducing the need for leg and foot rests.

Fixed-shell aircraft seats are typically found in economy and business class seating sections of an aircraft where the fixed-shell protects the living space of an aft-seated passenger and serves as a mounting structure for video monitors, tray tables and other amenities for use by the aft-seated passenger. Fixed-shell aircraft seats are capable of reclining to some degree within their fixed shell, but are typically incapable of reclining fully to achieve a horizontal bed.

Fixed-shell aircraft seats offer numerous benefits for premium economy passengers in an intermediary cabin. In a fixed-shell seat, the seat reclines inside its fixed-shell, providing an optimum rest position with plenty of legroom while preserving each passenger's personal space. Fixed-shell seats can also be equipped with a leg rest that can be adjusted in height, as well as an adjustable headrest.

The degree of seat back recline in a fixed-shell seat is limited by the seat pitch. Conventional fixed-shell seats with translating seat bottoms require a seat pitch greater than 1 meter, thereby sacrificing seating density. Conventional fixed shell seats also recline without cradling, thereby sacrificing comfort. Therefore, what is needed is a cradling mechanism for a fixed-shell seat that provides greater comfort in an equivalent or lesser conventional fixed-shell seat pitch.

### SUMMARY OF ILLUSTRATIVE EMBODIMENTS

It is therefore an object of the present disclosure to provide an aircraft passenger seat having a unique cradling motion created by the forward translation and lowering of a seat bottom in recline and a related counterbalancing mechanism that allows the seat to both return upright and prevent it from over accelerating into the reclined position.

It is another object of the disclosure to provide an aircraft seat having a unique cradling motion with greater comfort than prior art seats with an equivalent seat pitch.

It is another object of the disclosure to provide an aircraft passenger seat having a cradled seat bottom that lowers when the seat back is reclined to provide greater living space and reduce the need for leg and foot rests.

It is another object of the disclosure to provide a seat mechanism that allows the seat bottom to translate from the upright position forward into a cradle position in as little as 1 meter of seat pitch.

It is another object of the disclosure to provide an aircraft passenger seat including a moveable control mechanism for counterbalancing the weight of the passenger as the seat reclines and returns upright.

It is another object of the disclosure to provide a counterbalancing mechanism for aircraft seat movement that has a low spatial volume and weight.

To achieve the foregoing and other objects and advantages, in one embodiment an aircraft passenger seat including a seat bottom, a seat back pivotably attached to the seat bottom, a rigid seat support behind the seat back, left and right spreaders guiding the seat bottom forward and lower as the seat bottom moves from an upright sitting position to a cradle recline sitting position, a linkage arm linked with movement of the seat bottom, and a moveable control mechanism arranged between the linkage arm and a fixed seat frame member for counterbalancing passenger weight to return the seat bottom to the upright sitting position and prevent over acceleration into the cradle recline sitting position.

In another aspect, each of the left and right spreaders may define an arcuate roller rack along which vertically-oriented rollers on opposite sides of the seat bottom travel as the seat bottom moves between the upright and cradle recline sitting positions.

In another aspect, the vertically-oriented rollers may include a seat bottom attachment roller and an idler roller positioned forward of the seat bottom attachment roller in the arcuate roller rack.

In another aspect, the seat bottom attachment roller may be positioned at a rearwardmost end of the arcuate roller rack when the seat bottom is fully upright, and the idler roller may be positioned at a forwardmost end of the arcuate roller rack when the seat bottom is fully reclined.

In another aspect, the seat bottom may be horizontal in the upright sitting position and inclined in the direction of a forward end thereof in the cradle recline sitting position.

In another aspect, the seat may include an arcuate rail that moves with the seat bottom and a geared pinion timing axle meshed with teeth on the arcuate rail to keep opposite sides of the seat bottom running parallel.

In another aspect, the linkage arm and the arcuate rail may attach at the seat bottom attachment roller.

In another aspect, the linkage arm may be fixed at one end for movement with the seat bottom and pivotably attached proximate an opposite end thereof to the fixed seat frame member positioned beneath the seat bottom.

In another aspect, the locking gas spring may be arranged such that maximum force is exerted on the linkage arm when the seat bottom is closest to fully reclined, and when the seat bottom is in the upright sitting position the locking gas spring is fully extended and pushes against the linkage arm with minimum force.

In another aspect, the seat may include vertically-oriented forward rollers positioned proximate a forward end of each of the left and right spreaders on inboard sides thereof that travel along arcuate racks on opposite sides of the seat bottom.

According to another embodiment, an aircraft passenger seat configured for cradle recline movement includes a seat back pivotably connected to a seat bottom such that a seat bottom movement drives seat back movement between an upright sitting position and a reclined sitting position, a rigid seat support positioned behind the seat back, left and right spreaders guiding the seat bottom forward and lower as the seat bottom moves from the upright sitting position to the reclined sitting position, a linkage arm linked with movement of the seat bottom, and a passenger weight counterbalancing mechanism arranged beneath the seat bottom.

In another aspect, the seat back may bear against the rigid seat support as the seat back moves between the upright and reclined sitting positions.

In another aspect, the passenger weight counterbalancing mechanism may be a locking gas spring arranged such that maximum force of the locking gas spring is exerted on the linkage arm when the seat bottom is closest to fully reclined, and when the seat bottom is in the upright sitting position the locking gas spring is fully extended and pushes against the linkage arm with minimum force.

Embodiments of the teachings disclosed herein can include one or more or any combination of the above features and configurations.

Additional features, aspects and advantages of the innovations will be set forth in the detailed description which follows, and in part will be readily apparent to those skilled in the art from that description or recognized by practicing the teachings as described herein. It is to be understood that both the foregoing general description and the following detailed description present various illustrative embodiments, and are intended to provide an overview or framework for understanding the nature and character of the invention as it is claimed. The accompanying drawings are included to provide a further understanding of the teachings, and are incorporated in and constitute a part of this specification.

### BRIEF DESCRIPTION OF THE DRAWINGS

A more complete appreciation of the innovations and many of the attendant advantages thereof will be readily obtained as the same becomes better understood by reference to the following detailed description when considered in connection with the accompanying drawings, where:

FIG. 1 is a left side view of an aircraft passenger seat in an upright sitting position according to one embodiment;

FIG. 2 is a right side view of the seat of FIG. 1;

FIG. 3 is a detailed view of a cradling and counterbalancing mechanisms with the seat shown in an upright position;

FIG. 4 is a detailed view of the cradling and counterbalancing mechanism with the seat shown in a fully reclined position;

FIG. 5 is a comparative illustration showing both the upright and the fully relined positions of FIGS. 3 and 4;

FIGS. 6A and 6B are a left side view of an alternative seat embodiment including a cradle recline mechanism having an shortened arcuate linkage arm;

FIGS. 6C and 6D are a left side view of an alternative seat embodiment including a cradle recline mechanism having an extended arcuate linkage arm;

FIG. 7 is an isometric view of a curved bearing block suitable for use in the seat particularly suited to the alternative embodiments shown in FIGS. 6A & 6B;

FIG. 8 is a perspective view of a seating group including laterally-adjacent seats according to certain aspects of the disclosure;

FIG. 9A is a left side view of an example aircraft passenger seat in an upright sitting position according to an example linear translation embodiment;

FIG. 9B is a left side view of the example aircraft passenger seat of FIG. 9A in a reclined sitting position;

FIG. 9C is a right side view of the example aircraft passenger seat of FIG. 9A in an upright sitting position;

FIG. 9D is a right side view of the example aircraft passenger seat of FIG. 9A in a reclined sitting position;

FIG. 10A is a left side view of an example aircraft passenger seat in an upright sitting position according to an example planetary translation embodiment;

FIG. 10B is a left side view of the example aircraft passenger seat of FIG. 10A in a reclined sitting position;

FIG. 10C is a left side view of the example aircraft passenger seat of FIG. 10A in an upright sitting position demonstrating a counterbalance mechanism position;

FIG. 10D is a left side view of the example aircraft passenger seat of FIG. 10A in a reclined sitting position demonstrating the counterbalance mechanism position;

FIG. 10E is an overhead perspective view of the example aircraft passenger seat of FIG. 10A in a reclined sitting position demonstrating the counterbalance mechanism position;

FIG. 10F is an overhead perspective view of the example aircraft passenger seat of FIG. 10A in an upright sitting position demonstrating the counterbalance mechanism position; and

FIG. 11 is a close-up left side view of an example aircraft passenger seat in a recline seating position demonstrating differing recline seat angles possible using an adjustable height roller.

### DETAILED DESCRIPTION OF ILLUSTRATIVE EMBODIMENTS

Like reference numbers refer to like elements throughout the various drawings.

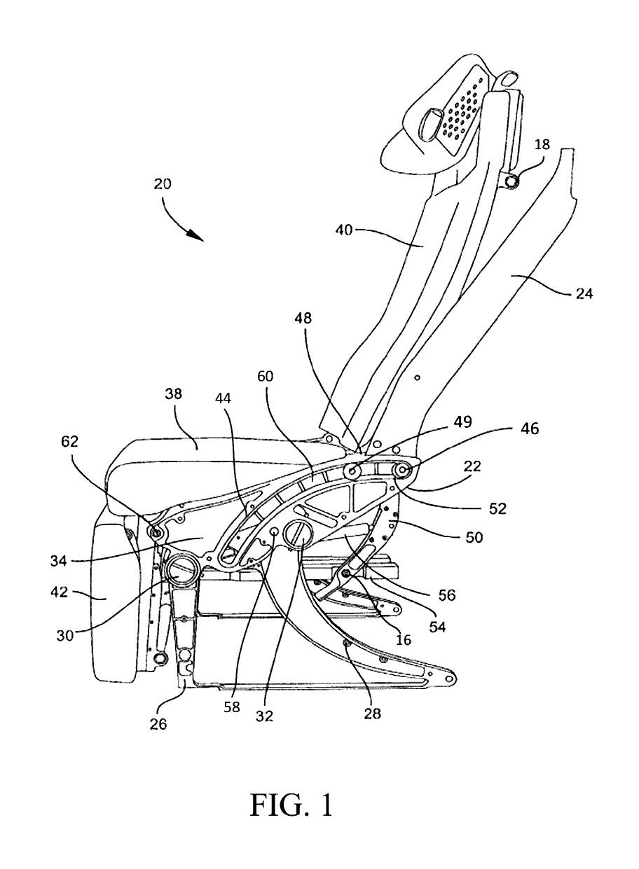

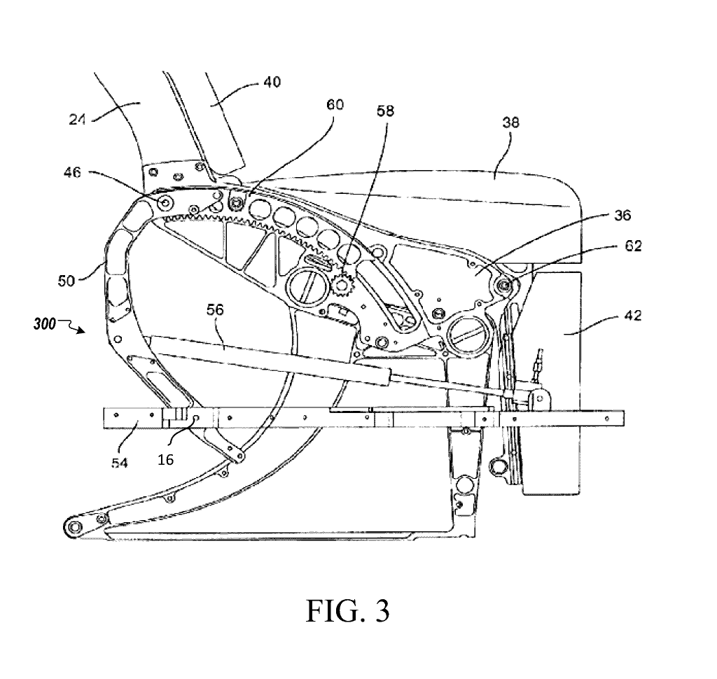

Referring to FIGS. 1-5, a passenger aircraft seat 20 employing a cradle recline motion according to one embodiment generally includes a seat base frame 22, a seat bottom 38, a seat back 40, and a rigid seat support (e.g., fixed-shell) 24. The seat back 40 is configured to recline within and relative to the rigid seat support 24 positioned behind the seat back 40. In one example, the seat back 40 may bear against the rigid seat support 24, such as by rollers 18. In an example, the seat bottom 38 is pivotably attached to the seat back 40 at by a pivoting attachment mechanism 48. The pivoting attachment mechanism 48, for example, is a hinged connection between the seat back and seat bottom such that a seat bottom movement, for example, a forward and vertical translation distances of the seat bottom 38, drives a seat back movement. In alternative examples, the seat back 40 can be pivotably attached to the seat bottom 38 by mating hinge segments connected by a pin (not shown), using a pivoting crossbar (not shown) with perpendicular mounting rods for mounting the seat back 40, or using a stable crossbar with mounting rods connected to the crossbar by bushings. In this arrangement, as the seat bottom 38 is driven forward and lower, the seat bottom 38 pulls the seat back 40 along therewith causing the seat back 40 to lower and recline within and relative to the rigid seat support 24. The seat 20 may optionally include a leg rest 42 that may move together with or independent of the movement of the seat bottom 38.

### Seat Base Frame

In an example, the seat base frame 22 generally can include front and rear legs 26, 28 and left and right spreaders 34, 36 that are attached to respective front and rear transverse structural members 30, 32 which may be shared with a laterally adjacent seat. The front and rear legs 26, 28 may attach to seat racks in the floor using conventional anti-rattle rack fasteners (not shown). The front and rear structural members 30, 32 cooperatively support the left and right spreaders 34, 36 configured to guide the movement of the seat 20 from an upright position to a reclined position and back again. In an example, the fixed-shell 24 can be fixed to the left and right spreaders 34, 36. Each of the left and right spreaders 34, 36 may define an arcuate roller rack (or track) 44 arranged to guide the movement of the seat bottom 38, and in particular, translate forward and lower the seat bottom 38 to recline the seat back 40. In other words, as the seat back 40 moves from the upright position to the reclined position, the seat bottom 38 simultaneously moves forward and lower to the floor.

In some embodiments, the seat 20 can have a rigid limited-size backrest (not shown) configured to be independent from the reclining movement of the seat bottom 38. In an example, the rigid limited-size backrest can be useful in a passenger seat row in front of a lavatory monument. In other embodiments, rather than a fixed-shell 24 designed for use with a single passenger seat, a passenger seating group (e.g., a group of two or three laterally adjacent passenger seats) may be positioned in front of a shared rigid shell.

### Seat Bottom

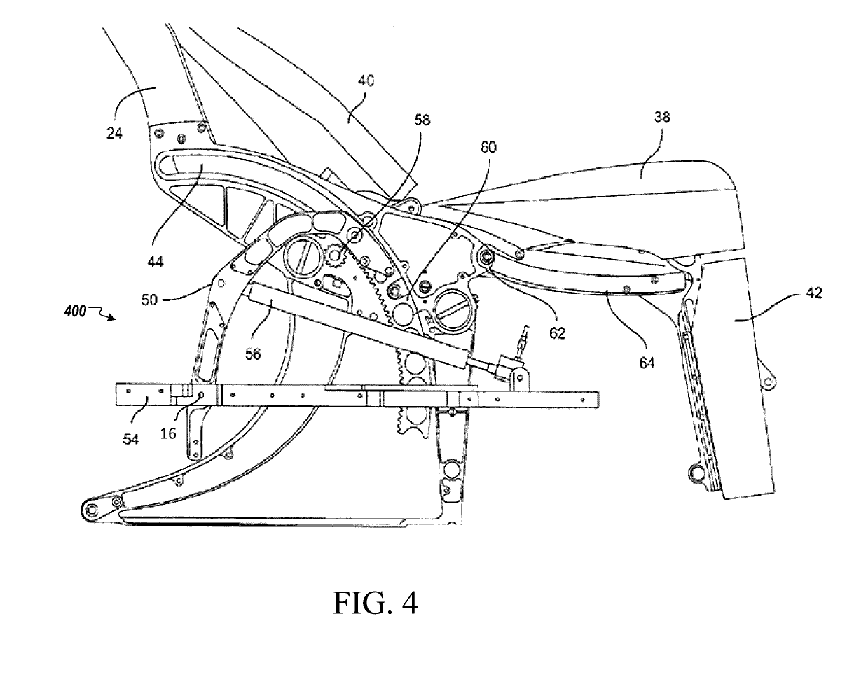

In some implementations, the seat bottom 38 includes a frame portion (e.g., seat pan) for guiding mechanical movement and a cushion portion for the comfort of the passenger. In an example, the frame portion of the seat bottom 38 includes a pair of vertically-oriented seat bottom attachment rollers 46, a pair of vertically-oriented idler rollers 49 attached to a pair of arcuate roller racks 60, and a pair of arcuate racks 64 defined on the opposite sides of the frame portion of the seat bottom 38 as best shown in FIG. 4.

In the illustrated example, the attachment roller 46 of the seat bottom 38 engages and is guided along the arcuate roller rack 44 of the left and right spreaders 34, 36. The left and right spreaders 34, 36 can further include a pair of vertically-oriented forward rollers 62 that are configured to travel along the arcuate racks 64 of the seat bottom 38 and help support the seat bottom 38 throughout the seat bottom movement.

In some embodiments, a pair of arcuate toothed side rails or arcuate roller racks 60 and a geared pinion timing axle 58 can be used to keep both sides of the seat bottom 38 running parallel throughout the seat bottom movement. In an example, the pair of arcuate roller racks 60 may ride along the arcuate roller rack 44 on rollers 46, 49 on the outboard side of the left and right spreaders 34, 36. Rollers 46 axis of rotation is also the pivoting (52) attachment point of the arcuate roller racks 60 to the seat bottom frame. Roller 49 is attached to the arcuate roller racks 60.

In some embodiments, a geared pinion timing axle 58, having at least one pinion gear on each end, is configured to be rotatably carried on the left and right spreaders 34, 36 and configured to synchronize rotation of the pinion gears to keep both sides of the seat bottom 38 running parallel. Each pinion gear on the end of the timing axle 58 is meshed with a respective arcuate roller rack 60 that moves along with the seat bottom 38. In an example, the geared pinion timing axle 58 and respective rails may be provided on both sides of the seat bottom 38.

### Reclining Movement

FIGS. 1, 2, and 3 show the seat 20 in an upright sitting position 300 required for taxi, takeoff and landing (TTOL). In the upright sitting position, the seat bottom 38 is generally horizontal and closest to the fixed-shell 24, the seat back 40 is at its steepest angle to the floor (i.e., closest to vertical), and the leg rest 42, when present, is stowed generally vertically against the front of the seat. In the fully reclined sitting position 400, as best shown in FIG. 4, the seat bottom 38 is moved forward and lower, the seat back 40 is reclined to a shallower angle to the floor, and the seat bottom 38 is inclined slightly to the front to cradle the seated passenger.

In an embodiment, a reclining movement, producing a travel arc, is controlled by a cradle recline mechanism 43a-c positioned on opposite sides of and beneath the seat bottom 38. In a particular embodiment, the cradle recline mechanism 43a-c allows the seat bottom 38 to translate from its upright sitting position approximately 23 centimeters forward into a cradle position in as little as 91.44 centimeters of seat pitch. In an example, the seat back 40 is attached to and pivots at the link 48 on the seat bottom 38 during the reclining movement.

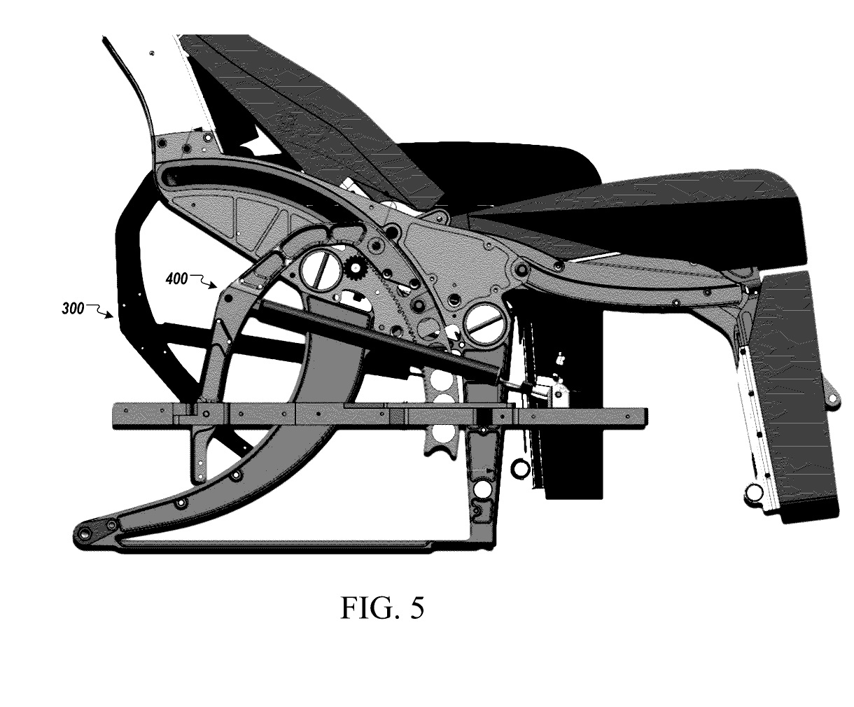

As best shown in FIG. 5, it can be seen that an angle between the seat back 40 and the seat bottom 38 opens the farther the seat bottom 38 translates forward. As the seat bottom 38 lowers towards the floor, for example by about 2.5 centimeters, as the seat bottom 38 translates forward, the rear of the seat bottom 38 lowers even more so, for example by about 6 centimeters. This seat bottom movement creates a change in angle of recline and provides a cradling effect that improves reclined comfort. Additionally, since the seat 20 in a reclined position is lower to the floor, there is more effective living space for the passenger compared to a typical linear translating seat mechanism. The seat bottom angles to provide approximately 16 degrees of cradle angle (when starting from a seven degree upright (TTL) seat bottom angle) while lowering the front edge of the seat bottom when fully reclined. Typically manually articulating seat bottoms raise the front edge of the seat bottom when reclined which prevents the improved living space this embodiment provides.

In the upright sitting position 300 (FIGS. 1, 2 and 3), in some embodiments, the attachment roller 46 is positioned at the rearward most end of the arcuate roller rack 44. The vertically-oriented idler rollers 49 are configured to lead the seat bottom movement. In the fully reclined sitting position 400 (FIG. 4), the idler roller 49 is positioned at the forwardmost end of the arcuate roller rack 44. In an aspect, the arcuate roller rack 44 can have a rack length configured to control an amount of travel of the seat bottom 38, and consequently an amount of seat back recline. The seat bottom movement can be customized, for example, by changing a shape and/or length of the arcuate roller rack 44.

### Cradle Recline Mechanism

The cradle recline mechanism 43a-c, in some embodiments, is configured to produce the travel arc of the reclining movement by forming a kinematic chain from different parts of the seat 20 including a moveable control mechanism such as a locking gas spring 56. The moveable control mechanism is configured to provide counterbalancing for the weight of the passenger as the seat reclines and returns upright in coordination with the kinematic chain of the cradle recline mechanism 43a-c.

### Arcuate Linkage Arm

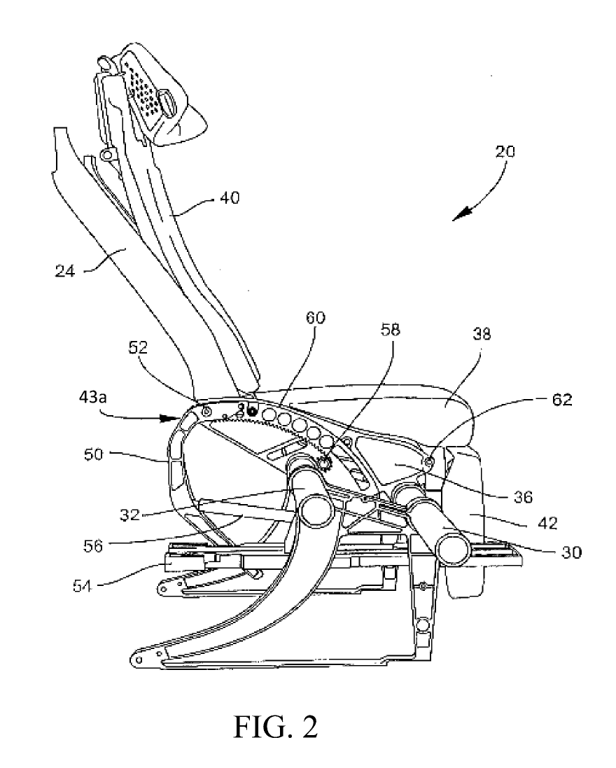

Referring to FIG. 2, in an embodiment, a cradle recline mechanism 43a includes an arcuate linkage arm 50 attached to at least one arcuate roller rack 60 that is configured to be connected and to move with the seat bottom 38 at a pivot axis point 52 about the attachment roller 46. The other end of the arcuate linkage arm 50, as illustrated, is pivotably connected at an arc pivot 16 to a fixed horizontal frame member 54 positioned beneath the seat 20 in a position elevated off the floor. The arc pivot 16 is a location where a pivot point of the travel arc can be defined by. In an example, the arc pivot 16 is a physical location within the kinematic chain.

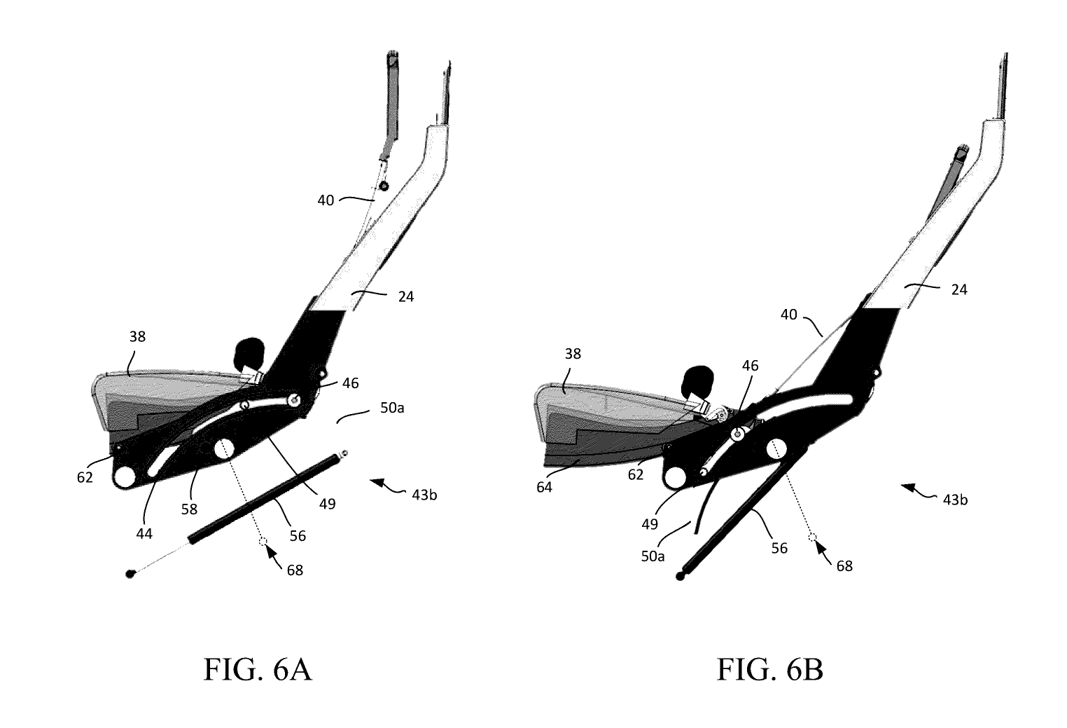

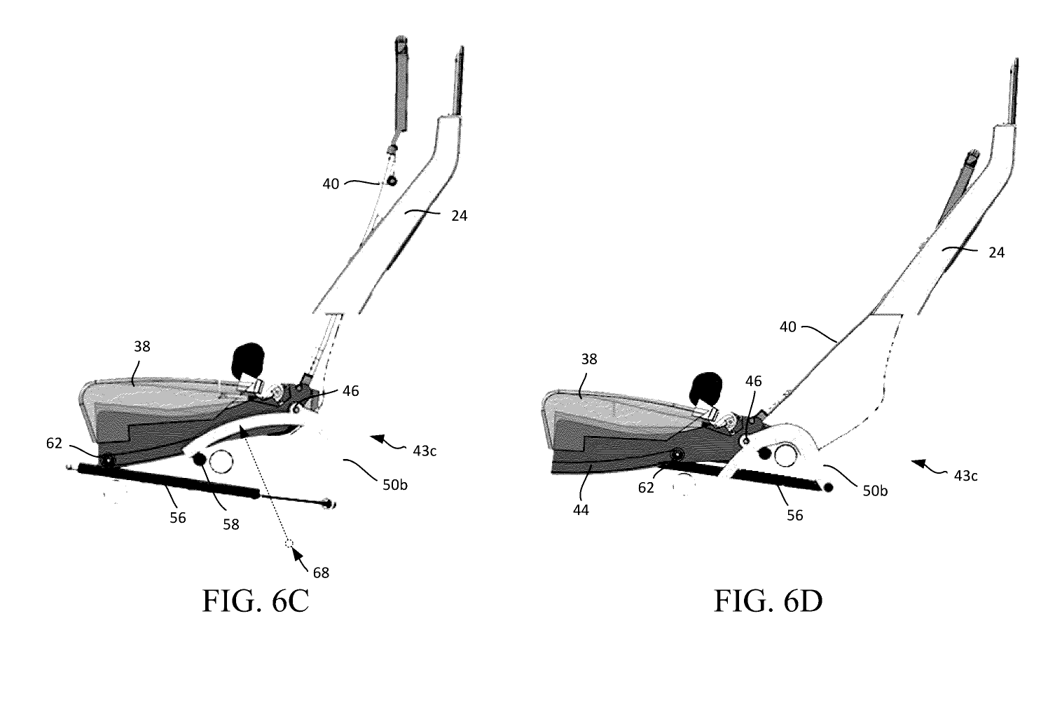

In an example, the arcuate linkage arm 50 and the arcuate roller rack 60 can separate pieces, as shown, such that either piece can be replaced as needed. Alternatively, the arcuate linkage arm 50 and the arcuate roller rack 60 can be made as one piece See FIGS. 6A-6D).

In an aspect, the arcuate linkage arm 50 is configured to have an arcuate shape such that a majority force is exerted on the arcuate linkage arm 50 when the seat bottom 38 is closest to the fully reclined position.

### Virtual Arc Pivot

Referring to FIGS. 6A-6D, in some embodiments, a cradle recline mechanism 43b-c can be configured to have a virtual arc pivot 68, where the pivot point of the travel arc is not on a physical location within the kinematic chain.

FIGS. 6A and 6B show a seat, in an upright position and fully reclined position respectively, having a cradle recline mechanism 43b including a shortened arcuate linkage arm 50a and elimination of the fixed horizontal frame member 54. The moveable control mechanism, shown here as the locking gas spring 56, can be connected between the shortened arcuate linkage arm 50a and at least one of the front and rear legs 26, 28 (not shown for clarity). In an aspect, the shortened arcuate linkage arm 50a is configured to have an arcuate shape such that a majority force is exerted on the shortened arcuate linkage arm 50a when the seat bottom 38 is closest to the fully reclined position. In an aspect, the idler roller 49 facilitates the virtual arc pivot 68.

In an example, with 5 inches of movement, the locking gas spring 56 can be configured to make 50% progressivity. When fully compressed (i.e. full recline position) the locking gas spring 56 is pushing against the arcuate linkage arm 50 about thirty-four degrees off tangency increasing the mechanical advantage of the locking gas spring 56 relative to the upright position. When fully extended (i.e. upright position) the locking gas spring 56 is pushing against the arcuate linkage arm 50 about sixty degrees off tangency of the travel arc which reduces the mechanical advantage of the locking gas spring 56.

FIGS. 6C and 6D show a seat, in an upright position and fully reclined position respectively, having a cradle recline mechanism 43c including an elongated arcuate linkage arm 50b. The elongated arcuate linkage arm 50b is configured to include the functionality of the arcuate roller rack 60.

### Bearing Block

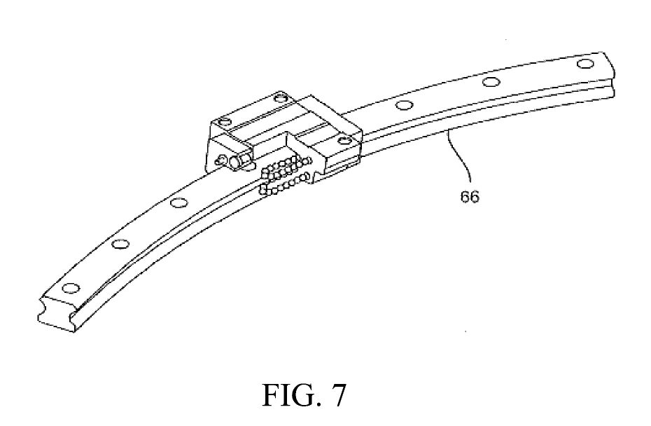

Referring to FIG. 7, the cradle recline mechanism 43a-c may utilize a curved bearing block 66 in place of one of the integrated spreader roller assemblies described above. An example of a bearing block and curved rail assembly suitable for use in the seat is the R Guide produced by THK America, Inc., (Schaumburg, Ill.). Use of the curved bearing block 66 may allow for elimination of the arcuate roller rack 60 on the spreader attached to the arcuate linkage arm 50, as well as potentially the need for the timing axle 58 that ensures alignment of the roller racks on either side of the seat bottom 38.

### Moveable Control Mechanism

In some embodiments, the moveable control mechanism can be any tensioner device having a locking function and an unlocking function to lock and to unlock the travel of a rod along a stroke course, where the locking and unlocking can be implemented at any desirable location along the stroke course. For example, the moveable control mechanism can be a hydraulic tensioner where the locking function and the unlocking function are implemented through valves actuated by a release pin to disenable and enable hydraulic fluids to flow through a piston connected to the rod. The hydraulic fluids can be gases, e.g., air or nitrogen, fluids, e.g., mineral oils, synthetic oils, or water, or the combination of both. In this manner, rather than actuating between a first position and a second position, the adjustable passenger seat features may be adjustable along a number of incremental positions in a path between a first position and a second position.

In certain embodiments, the moveable control mechanism can have an elastic locking function to provide better damping and comfort to a passenger. For the elastic locking function once the rod is locked at the desirable location the rod can be pushed and pull when a predetermined amount of force is applied to the rod. For example, the elastic locking function can be implemented via a floating piston placed around the rod to separate two different hydraulic fluid e.g. air and oil. In certain embodiments, the moveable control mechanism can have an rotary damper that is only engaged during the first few degrees of motion as the seat leaves the upright position.

Furthermore, in some embodiments, the moveable control mechanism can include a telescopic mechanism to extend the stroke course of the rod and increase the articulation and/or deployment of seat elements, (e.g., the seat back, the leg rest, and the seat bottom) that are actuated by the moveable control mechanism.

In an example, the moveable control mechanism is a locking gas spring 56 that is arranged beneath the seat bottom 38 and is connected at one end to the arcuate linkage arm 50 and at the other end to the fixed horizontal frame member 54. The locking gas spring 56 also accommodates infinite adjustability. In an aspect, the roller and linkage design allows a moveable control mechanism with a considerably shorter stroke length than conventional seat translation mechanisms, which minimizes the mechanisms spatial volume and thus weight.

In the embodiment presented in FIGS. 1-3, the locking gas spring 56 is arranged such that the most force is exerted on the arcuate linkage arm 50 when the seat bottom 38 is closest to the fully reclined position. As the locking gas spring 56 nears the compressed state (i.e., full recline position) the locking gas spring 56 pushes on the arcuate linkage arm 50 tangent to the travel arc, thus maximizing the mechanical advantage of the locking gas spring 56 relative to the upright sitting position. When the locking gas spring 56 is fully extended (i.e., upright sitting position), the locking gas spring 56 is pushing against the arcuate linkage arm 50 at, for example, a 51° off tangency of the travel arc, which reduces an mechanical advantage of the locking gas spring 56 at the top of the travel arc. Very little force is needed at the top of the travel arc, so this arrangement, along with the high progressivity (300%) of the locking gas spring 56 minimizes the force at the start of the travel arc when reclining. See, for example, FIG. 5 for comparative purposes of the locking gas spring 56 in the upright and reclined sitting positions.

In an example, the moveable control mechanism can be a coil spring such as a power spring or spring reels that can provide the rotary motion which would be stored on recline. In an aspect the coil spring has a relatively flat torque curve that can be beneficial for smooth movement. In another example, the moveable control mechanism can be a linear actuator. In another embodiment, the moveable control mechanism can include a motor (not shown) configured to controllably rotate the timing axle 58. In an aspect, the motor can be connected to circuitry, power, and a controller configured to be operated by the passenger.

### Leg Rest Movement

As shown in FIG. 5, the leg rest 42 is pivotably attached to the front of the seat bottom 38 such that the leg rest 42 is driven forward with the forward movement of the seat bottom 38, however, extends independently of the movement of the seat bottom 38. In this arrangement, the leg rest 42 may steplessly move between a first position in which the leg rest 42 is stowed generally vertically along the front of the seat, and a second position in which the leg rest 42 is generally horizontal. A leg rest movement, for example, can be achieved and controlled by a linear actuator positioned beneath the seat bottom 38 and attached to the leg rest 42.

### Seating Group

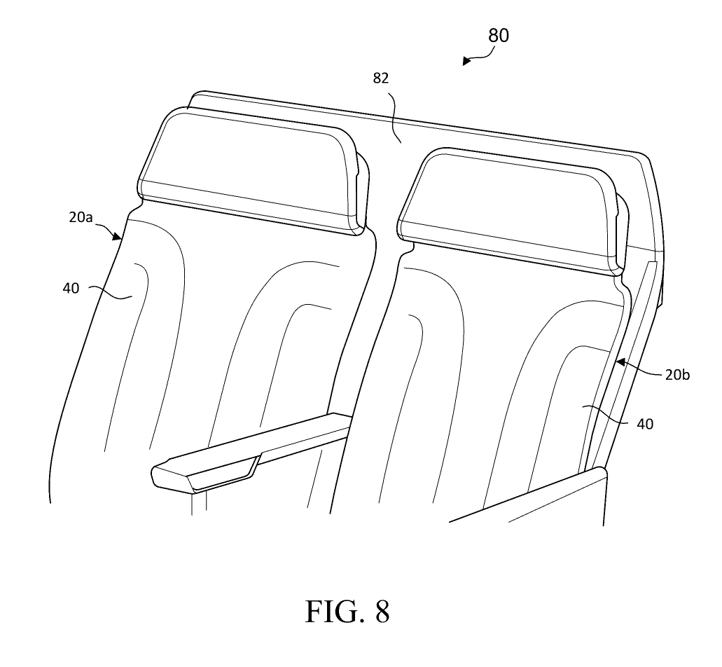

Referring now to FIG. 8, in accordance with some implementations, two or more seats can be configured to form a seating group 80 to provide better comfort and privacy is illustrated. For example, the seating group 80 generally includes first and second laterally-adjacent passenger seats 20a, 20b. A rear privacy shell 82 is positioned behind the seat backs 40 and extends along a width of the seating group 80. The rear privacy shell 82 can be used in place of the fixed-shell 24 for an individual seat.

The rear privacy shell 82 may be formed from lightweight durable plastics or other material and may serve to house electronics, electrical connections, data connections, etc., as well as serve to support tray tables, storage compartments, etc., for use by aft-seated passengers in the row behind the seating group 80. The rear privacy shell 82 may be supported by the seat frame as shown, or may be freestanding on the floor. In other implementations, the seating group 80 may include a greater number of seats and consoles than shown, for example, three seats and two center consoles between each seat. Alternatively, the seating group 80 may include a single seat and a console positioned adjacent to one side of the single seat. Multiple like seating groups 80 may be arranged into rows to form a seating class with the aircraft cabin.

### Direct Linear Translation Mechanism

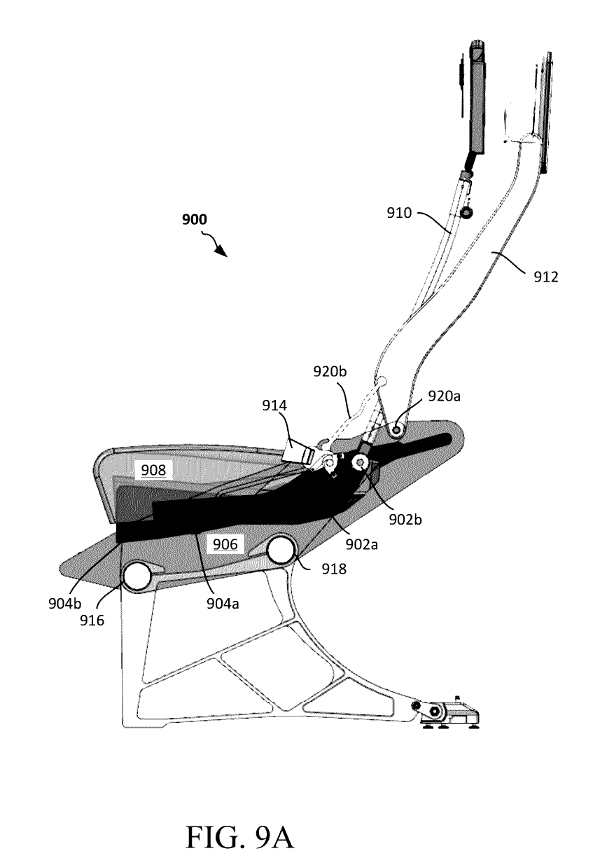

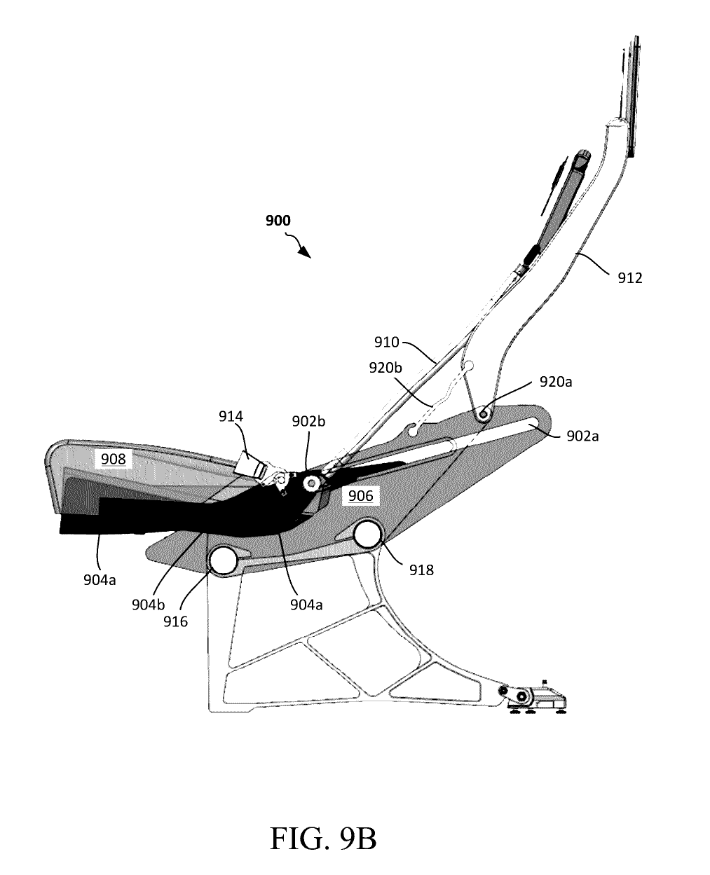

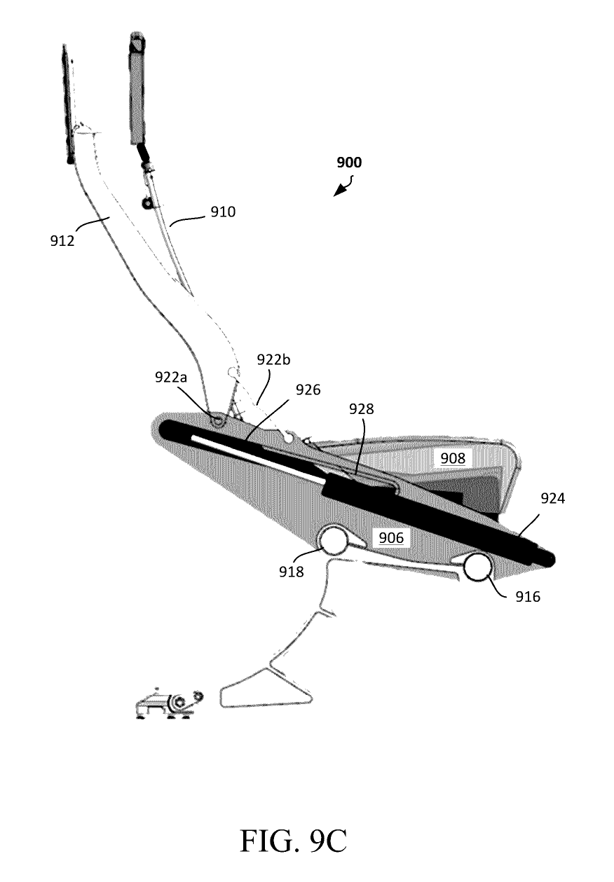

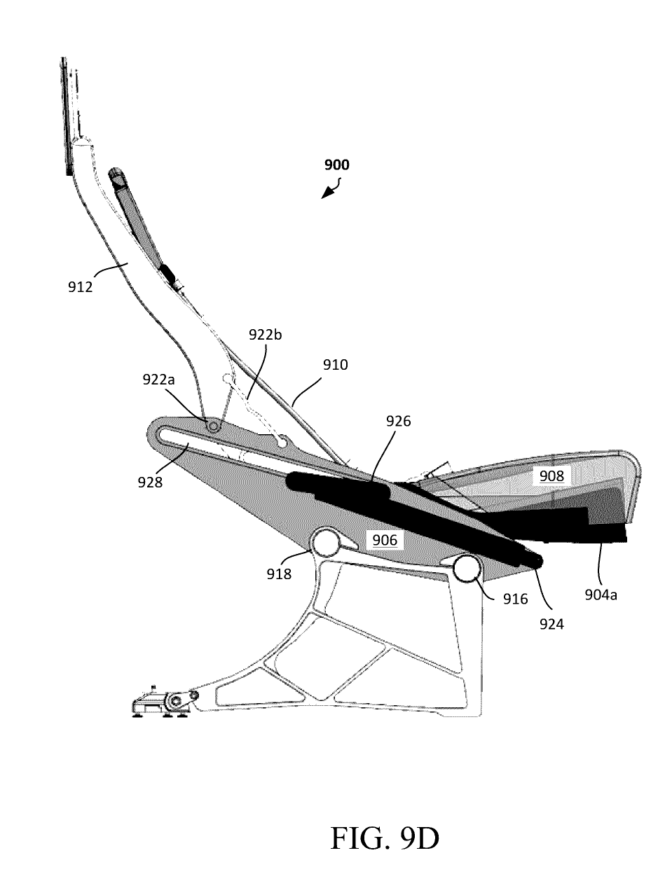

Referring to FIGS. 9A-9E, an aircraft passenger seat 900 employing a cradle recline motion, in some embodiments, includes a direct linear translation mechanism provided by a set of roller mechanisms, including an upper roller mechanism 902 disposed generally between a rear of a seat base frame 906 and a center region of the seat base frame 906 and a lower roller mechanism 904 disposed generally between the center region of the seat base frame 906 and an end of a seat bottom 908. Each roller mechanism 902, 904, as illustrated, includes a roller rack 902a, 904a and a roller 902b, 904b. The paths of each roller rack 902a, 902b slope in a generally downward direction from a seat back 910 end of the aircraft passenger seat 900 towards a front of the seat bottom 908. An end portion of the upper roller rack 902a, in some embodiments, is disposed directly above beginning portion of the lower roller rack 902a, such that the paths of the roller racks 902a, 904a overlap. The rollers 902b, 904b, in some embodiments, are different types of rollers. For example, the upper roller 902b may be a bearing roller, while the lower roller 904b may be a bevel roller. In other embodiments, the rollers are each of the same type.

As shown in FIG. 9A, in an upright sitting position, in some embodiments, the upper roller 902b is in an upper position in the upper roller rack 902a, disposed generally beneath a foremost portion of a rigid seat support (e.g., fixed shell) 912 disposed behind the seat back 910. Conversely, the lower roller 904b, in the upright sitting position, is disposed generally at an edge of the seat bottom 908 opposite the seat back 910.

Turning to FIG. 9B, in effecting translation between the upright sitting position and the reclined sitting position, in some embodiments, the upper roller 902b moves along the upper roller rack 902a in a generally fore direction, while the lower roller 904b moves along the lower roller rack 904a in a generally aft direction. Thus, in the reclined sitting position, the upper roller 902b translates to a position generally centrally located on the seat pan 906. However, due to the forward translation of the seat bottom 908, although the lower roller 904b translates to a position toward the seat back end of the seat bottom 908, the roller 904b remains positioned substantially in a same location (e.g., as illustrated, vertically above a forward structural member 916 supporting the seat pan 906). In the reclined sitting position, as illustrated in FIG. 9B, the seat bottom is now tilted at a downward angle toward the seat back 910, and the seat bottom 908 extends beyond the seat base frame 906. The change in angle of recline, for example, may be similar to those described above in relation to the upright sitting position 300 and the fully reclined sitting position 400. In a particular example, the seat bottom 908 may extend approximately seven inches in the forward direction, and the angle of upward rotation of the front of the seat bottom 908 may be approximately seven degrees.

The seat back 910, in some implementations, is pivotably connected to the seat bottom 908 such that, during translation between the upright sitting position and the reclined sitting position, the seat back 910 moves with the seat bottom 908. An angle of recline of the seat back 910, in some embodiments, is controlled by the positioning of the rigid seat support (e.g., fixed shell) 912. For example, the seat back 910 may slide along the rigid seat support 912 while being pulled downward and forward by the movement of the seat bottom 908.

In some implementations, a seat belt connector 914 is connected to the seat bottom 908 such that the seat belt connector 914 translates with the seat bottom 908 during actuation between the upright sitting position and the reclined sitting position, and vice-versa. For example, as illustrated in FIG. 9A, in the upright sitting position, the seat belt connector 914 is disposed above and behind a rear structural support member 918, while in the reclined sitting position illustrated in FIG. 9B, the seat belt connector 914 is disposed substantially above the front structural support member 916 and forward of the rear structural support member 918.

In some implementations, the rigid seat support 912 comprises an emergency translation mechanism 920 for allowing the rigid seat support 912 to pivot forward in an emergency situation. The emergency translation mechanism 920, for example, may be designed to free the rigid seat support 912 for forward pivoting upon a pivot connection 920a by breaking a connector 920b (e.g., “compression fuse”) disposed between the rigid seat support 912 and the seat frame base 906. The connector 920b, for example, may be designed to physically fail (e.g., snap or buckle) upon receipt of a threshold weight load. The load, in some embodiments, may be a dynamic load such that, upon impact from behind by an aft seated passenger during an emergency deceleration, the connector 920b fails to support the upright position of the rigid seat support 912, allowing the rigid seat support to pivot forwards at the pivoting connection 920a rather than maintaining position and potentially causing injury to the aft-seated passenger. Turning to FIG. 9C, as illustrated on the right side of the passenger seat 900, a mirror emergency translation mechanism 922 is mounted between the rigid seat support 912 and the seat base frame, allowing the rigid seat support 912 to pivot toward a passenger seated in the passenger seat 900 upon physical failure of the connectors 922a and 922b.

As illustrated in FIG. 9C, in some implementations, a linearly actuated movable control mechanism, shown here as locking gas spring 924, is mounted generally along the seat pan 906. Although illustrated as floating in air, in some embodiments, the movable control mechanism 924 may be mounted within a center console between the passenger seat 900 and an adjacent passenger seat, such that the movable control mechanism 924 is hidden and protected from passenger access. The movable control mechanism is connected to the seat bottom, in some embodiments, by a mounting arm 926 disposed within a linear rack 928. As the seat bottom 908 moves forward and lower into the cradle recline sitting position, for example, the movable control mechanism 924 is compressed by pushing the seat-mounted end of the moveable control mechanism 924, via the mounting arm 926, along the linear rack 928. For example, as illustrated in FIG. 9D, the movable control mechanism 924 is in a fully compressed position when the passenger seat 900 is in a fully reclined position. The movable control mechanism 924, in some embodiments, includes an infinite position locking ability, such that the passenger seat recline can be adjusted in any intermediate position between the fully upright sitting position and the fully reclined sitting position. Further, the movable control mechanism 924 may provide motion damping (e.g., acceleration control) during translation of the passenger seat 900 between the upright sitting position and the reclined sitting position.

### Planetary Translation Mechanism

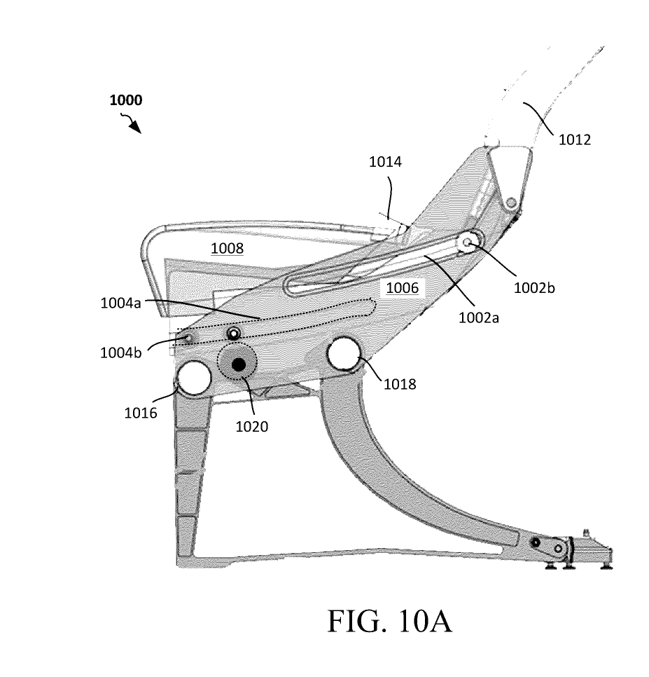

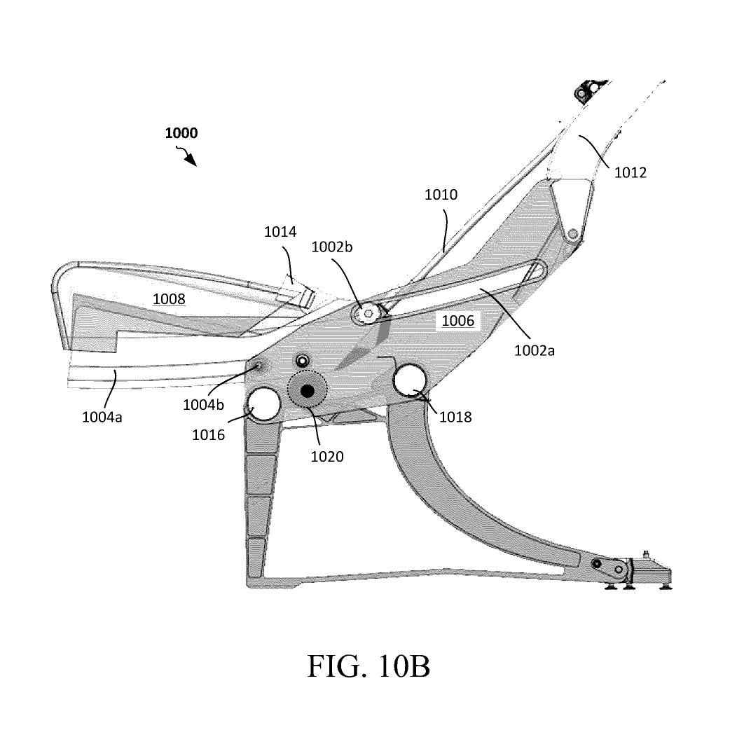

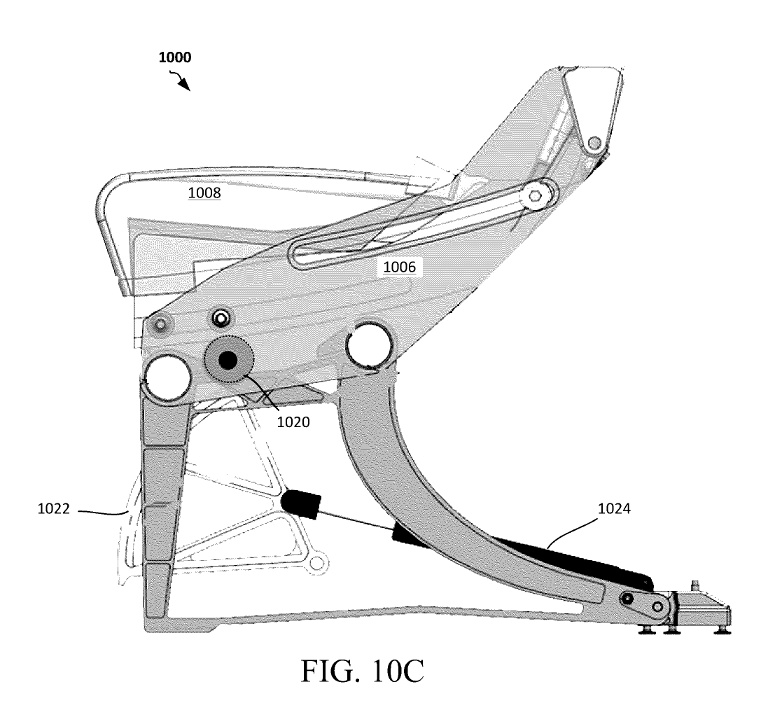

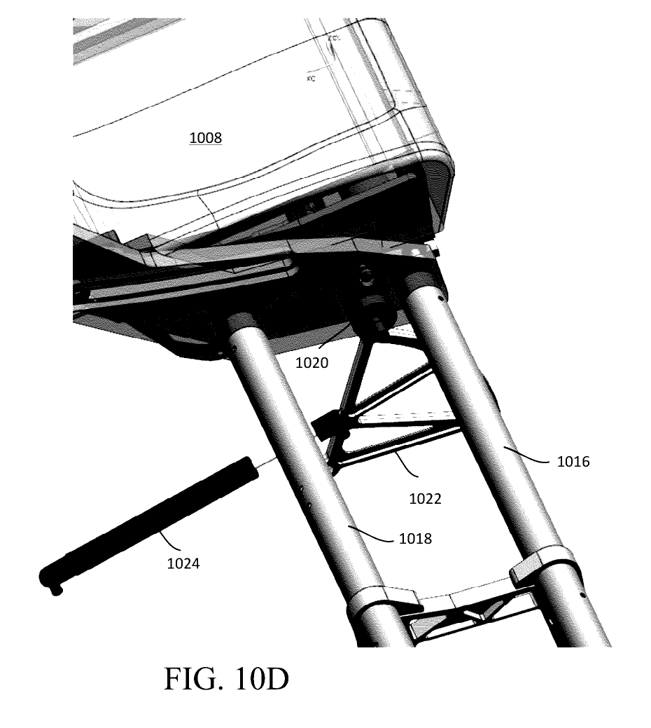

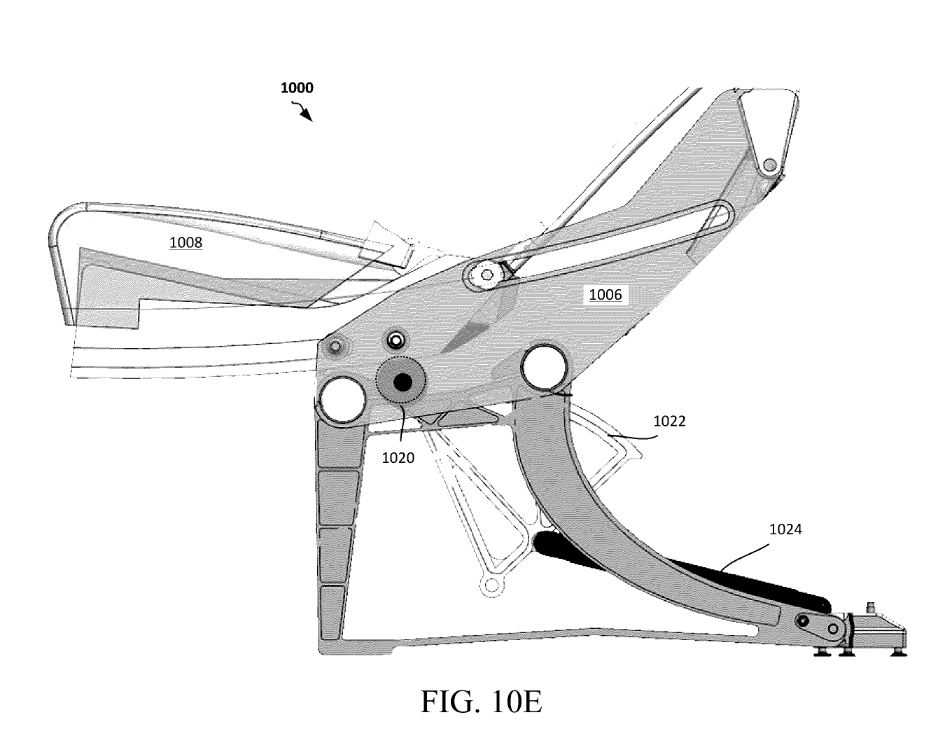

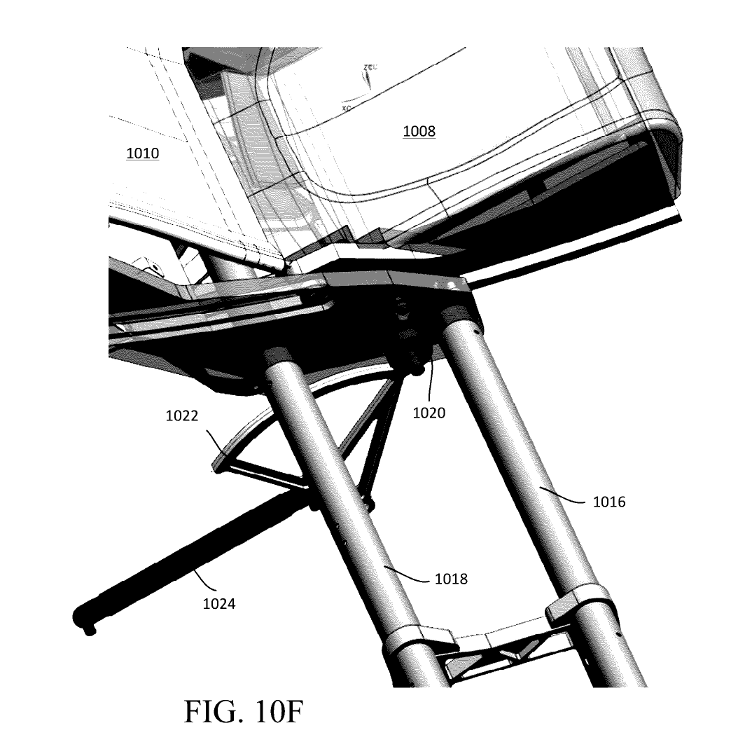

Referring to FIGS. 10A-10F, an aircraft passenger seat 1000 employing a cradle recline motion, in some embodiments, includes a planetary translation mechanism provided by a set of roller mechanisms, including an upper roller mechanism 1002 disposed generally between a rear of a seat bottom 1008 and a center region of a seat base frame 1006 and a lower roller mechanism 1004 disposed generally, as illustrated in FIG. 10A, from a position vertically above a rear structural member 1018 to an end of the seat bottom 1008, as well as a pinion shaft assembly 1020 disposed in the seat frame 1006 aft of a forward structural member 1016. Each roller mechanism 1002, 1004, as illustrated, includes a roller rack 1002a, 1004a and a roller 1002b, 1004b. The paths of each roller rack 1002a, 1002b slope in a generally downward direction from a seat back 1010 (illustrated, for example, in FIG. 10B) end of the aircraft passenger seat 1000 towards a front of the seat bottom 1008. An end portion of the upper roller rack 1002a, in some embodiments, is disposed directly above beginning portion of the lower roller rack 1004a, such that the paths of the roller racks 1002a, 1004a overlap.

As shown in FIG. 10A, in an upright sitting position, in some embodiments, the upper roller 1002b is in an upper position in the upper roller rack 1002a, disposed generally beneath a foremost portion of a rigid seat support (e.g., fixed shell) 1012 disposed behind the seat back 1010. Conversely, the lower roller 1004b, in the upright sitting position, is disposed generally at an edge of the seat bottom 1008 opposite the seat back 1010.

Turning to FIG. 10B, in effecting translation between the upright sitting position and the reclined sitting position, in some embodiments, the upper roller 1002b moves along the upper roller rack 1002a in a generally fore direction, while the lower roller 1004b moves along the lower roller rack 1004a in a generally aft direction. Thus, in the reclined sitting position, the upper roller 1002b translates to a position generally centrally located on the seat pan 1006. However, due to the forward translation of the seat bottom 1008, although the lower roller 1004b translates to a position toward the seat back end of the seat bottom 1008, the roller 1004b remains positioned substantially in a same location (e.g., as illustrated, vertically above the forward structural member 1016 supporting the seat pan 1006). In the reclined sitting position, as illustrated in FIG. 10B, the seat bottom is now tilted at a downward angle toward the seat back 1010, and the seat bottom 1008 extends beyond the seat base frame 1006. The change in angle of recline, for example, may be similar to those described above in relation to the upright sitting position 300 and the fully reclined sitting position 400. In a particular example, the seat bottom 1008 may extend approximately nine inches in the forward direction, and the angle of upward rotation of the front of the seat bottom 908 may be approximately seven degrees.

The seat back 1010, in some implementations, is pivotably connected to the seat bottom 1008 such that, during translation between the upright sitting position and the reclined sitting position, the seat back 1010 moves with the seat bottom 1008. An angle of recline of the seat back 1010, in some embodiments, is controlled by the positioning of the rigid seat support (e.g., fixed shell) 1012. For example, the seat back 1010 may slide along the rigid seat support 1012 while being pulled downward and forward by the movement of the seat bottom 1008.

In some implementations, a seat belt connector 1014 is connected to the seat bottom 1008 such that the seat belt connector 1014 translates with the seat bottom 1008 during actuation between the upright sitting position and the reclined sitting position, and vice-versa. For example, as illustrated in FIG. 10A, in the upright sitting position, the seat belt connector 1014 is disposed above and behind the rear structural support member 1018, while in the reclined sitting position illustrated in FIG. 10B, the seat belt connector 1014 is disposed substantially above the front structural support member 1016 and forward of the rear structural support member 1018.

In some implementations, the pinion drive assembly 1020 serves to drive the seat motion. Further, in some embodiments, the pinion drive assembly 1020 protects against racking of the seat tracks. Turning to FIG. 10C, in some embodiments, the pinion drive assembly 1020 is connected to a drive linkage 1022 to with gear rack, driven by a moveable control mechanism 1024 (e.g., locking gas spring). Although illustrated as floating in air, in some embodiments, the movable control mechanism 1024 may be mounted within a center console between the passenger seat 1000 and an adjacent passenger seat, such that the movable control mechanism 1024 is hidden and protected from passenger access. As the seat bottom 1008 moves forward and lower into the cradle recline sitting position, for example, the movable control mechanism 1024 is compressed by the drive linkage 1022 rotating from a first position illustrated in FIGS. 10C and 10D to a second position illustrated in FIGS. 10E and 10F. For example, as illustrated in FIG. 10E, the movable control mechanism 1024 is in a fully compressed position when the passenger seat 1000 is in a fully reclined position. As can be seen through a comparison of FIGS. 10D and 10F, due to the travel of the drive linkage 1022, the travel of the movable control mechanism 1024 can be reduced. For example, a locking gas spring having a stroke of approximately three inches may be used, in this configuration, to enable passenger seat movement of up to nine inches.

The movable control mechanism 1024, in some embodiments, includes an infinite position locking ability, such that the passenger seat recline can be adjusted in any intermediate position between the fully upright sitting position and the fully reclined sitting position. Further, the movable control mechanism 1024 may provide motion damping (e.g., acceleration control) during translation of the passenger seat 1000 between the upright sitting position and the reclined sitting position.

### Seat Bottom Tilt Adjustment

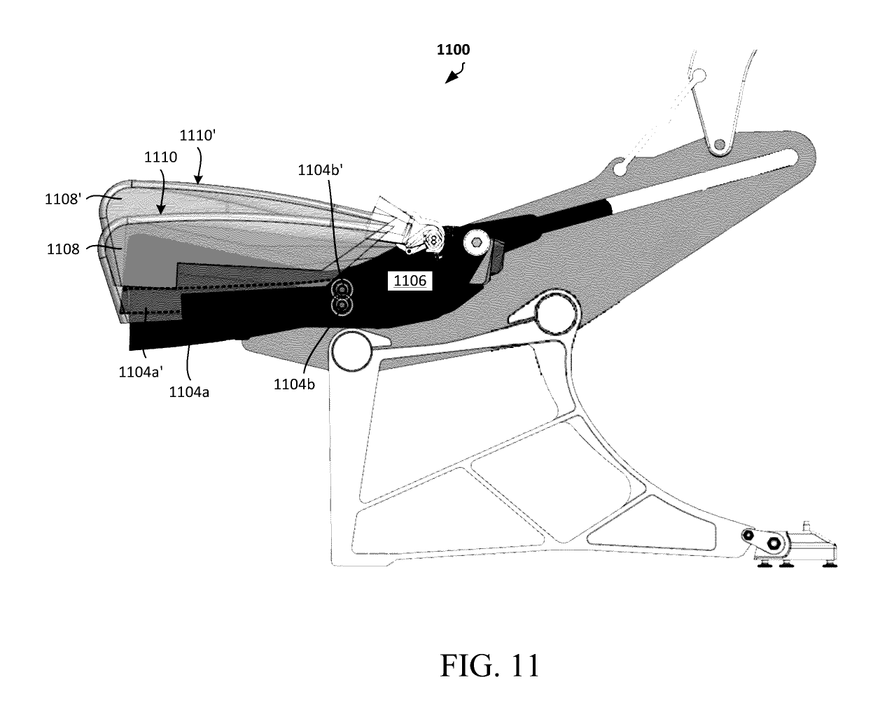

Turning to FIG. 11, in some implementations, the seat is height-adjustable in relation to the seat bottom such that a passenger seat 1100 is configurable to adjust a seat bottom tilt 1110 in either a flat recline position or in a cradle recline. In an example, the seat can include a seat frame base 1106 having an adjustable position for the lower roller 1104b configured to adjust the seat bottom tilt 1110 when the position is adjusted. In an example, the position of the lower roller 1104b can be adjusted on the seat frame base 1106 using a spring loaded pin and slot mechanism. In an example, the position of the lower roller 1104b can be adjusted on the seat frame base 1106 using a lever arm (not shown) configured to reduce a force needed to adjust the position of the lower roller 1104b. In an example, the lower roller 1104b can be positioned on the seat frame base 1106 at a first position, resulting in the seat bottom 1108 and lower roller rack 1104a having a first seat bottom tilt 1110. The lower roller 1104b′ can be positioned on the seat frame base 1106 at an alternative position, resulting in the seat bottom 1108′ and lower roller rack 1104a′ having a different seat bottom tilt 1110′.

Although illustrated as providing two choices for lower roller rack 1104a positioning, in other embodiments, the passenger seat 1100 may be adjustable between a greater number of positions. In this manner, in addition to straight recline and cradle recline, an angle of cradle recline may be selectable. In a particular example, the angles for selection may include about 0 degrees, about four degrees, and about seven degrees.

The foregoing detailed description of the innovations included herein is not intended to be limited to any specific figure or described embodiment. One of ordinary skill would readily envision numerous modifications and variations of the foregoing examples, and the scope of the present disclosure is intended to encompass all such modifications and variations. Accordingly, the scope of the claims presented is properly measured by the words of the appended claims using their ordinary meanings, consistent with the descriptions and depictions herein.

1. A cradle recline mechanism for an aircraft passenger seat, comprising:
a means for guiding a seat bottom of the aircraft passenger seat forward and lower as the seat bottom moves from an upright sitting position to a cradle recline sitting position, wherein the means for guiding lowers a rear portion of the seat bottom more than a front portion of the seat bottom, causing the seat bottom to angle upwards from a bottom edge of the seat back;
a pivoting attachment mechanism attaching a seat back of the passenger seat to the seat bottom, such that the seat back moves forward and lower with the seat bottom;
a seat support disposed behind the seat back, wherein the seat support maintains an aftmost position of the seat back during movement of the seat back into the cradle recline sitting position; and
a means for counterbalancing passenger weight to return the passenger seat to the upright sitting position and for preventing over-acceleration into the cradle recline sitting position.

2. The cradle recline mechanism of claim 1, wherein the means for preventing over-acceleration comprises a locking gas spring.

3. The cradle recline mechanism of claim 1, wherein the pivoting attachment mechanism comprises mating hinge segments connected by a pin.

4. The cradle recline mechanism of claim 1, wherein the means for guiding comprises at least a first roller configured to roll along a first arcuate roller rack, the first roller rack having a first end positioned higher than a second end.

5. The cradle recline mechanism of claim 4, wherein the means for guiding comprises an arc pivot.

6. The cradle recline mechanism of claim 5, wherein the arc pivot comprises an arcuate toothed side rail attached to the end of the first roller, and a pinion gear.

7. The cradle recline mechanism of claim 1, wherein the rigid seat support comprises a fixed shell support positioned aft of the seat back.

8. An aircraft passenger seat, comprising:
left and right spreaders;
a seat pan mounted between the left and right spreaders;
a seat back pivotably attached to the seat pan;
a fixed seat back support positioned aft of the seat back; and
a set of rollers configured to roll along roller racks, each roller rack including a first end positioned higher than a second end;
wherein the seat pan is mounted to the left and right spreaders via the set of rollers and the roller racks such that, upon moving from an upright sitting position to a reclined sitting position, the rollers move from the first ends of the roller racks to the second ends of the roller rack to lower the seat pan from an upper position to a lower position, wherein a rear portion of the seat bottom is lower than a front portion of the seat bottom in the reclined sitting position.

9. The aircraft passenger seat of claim 8, wherein, upon moving from an upright sitting position to a reclined sitting position, the seat back angles downward with the rear portion of the seat pan, and the fixed seat back support limits a recline angle of the seat back.

10. The aircraft passenger seat of claim 9, wherein the fixed seat back support comprises a fixed shell positioned behind at least the seat back of the passenger seat.

11. The aircraft passenger seat of claim 8, further comprising a passenger weight counterbalancing mechanism for counterbalancing passenger weight to return the seat pan to the upright sitting position and to prevent over acceleration of the seat pan into the reclined sitting position.

12. The aircraft passenger seat of claim 11, wherein the counterbalancing mechanism comprises a tensioner device having a locking function and an unlocking function to lock and to unlock the travel of a rod along a stroke course.

13. The aircraft passenger seat of claim 12, wherein the counterbalancing mechanism accommodates multiple stages of adjustable sitting positions between the upright sitting position and the reclined sitting position.

14. The aircraft passenger seat of claim 11, wherein the counterbalancing mechanism interoperates with the movement of the set of rollers via an arc pivot.

15. The aircraft passenger seat of claim 14, wherein the arc pivot is a virtual pivot mechanism.

16. The aircraft passenger seat of claim 8, further comprising a leg rest pivotably attached to the front of the seat pan.

17. The aircraft passenger seat of claim 16, wherein the leg rest is configured to extend independently of movement into the reclined sitting position.
